(19) United States
(12) Patent Application Publication
(10) Pub. No.: US 2013/0182638 A1
(43) Pub. Date: Jul. 18, 2013

(54) Enhancements to Support Mobility Load Balancing for Relay

(71) Applicants: Wei Hua Zhou, Beijing (CN); Simone Redana, Munich (DE); Ingo Viering, Munich (DE); Richard Waldhauser, Munich (DE)

(72) Inventors: Wei Hua Zhou, Beijing (CN); Simone Redana, Munich (DE); Ingo Viering, Munich (DE); Richard Waldhauser, Munich (DE)

(73) Assignee: NOKIA SIEMENS NETWORKS OY, Espoo (FI)

(21) Appl. No.: 13/816,801

(22) PCT Filed: Aug. 13, 2010
(86) PCT No.: PCT/EP10/61835

§ 371 Date: Apr. 1, 2013

(51) Int. Cl. H04W 40/22

(52) U.S. Cl. CPC H04W 40/22
USPC 370/315

(57) ABSTRACT

The present invention provides methods, apparatuses, and a computer program product for enhancements to support Mobility Load Balancing for Relay. The present invention discloses receiving a message including first parameters regarding a link between a relay entity and a base station entity, calculating second parameters regarding the link between the relay entity and the base station entity, placing the calculated second parameters into the message, and forwarding the message including the first and second parameters to nodes that are connected to the base station.

### FIELD OF THE INVENTION

The invention relates to the field of load balancing. In particular, the invention relates to methods, apparatuses, and a computer program product for enhancements to support mobility load balancing for relay.

### BACKGROUND OF THE INVENTION

Relay is a technique for improving e.g. the coverage of high data rates, group mobility, temporary network deployment, the cell-edge throughput and/or providing coverage in new areas. A Relay Node (RN) helps an enhanced NodeB (eNB) to communicate with user equipments (UE) that is located at the cell edge by forwarding the data from the UE to the eNB and vice versa. An eNB in a relay configuration is also named Donor eNB (DeNB). This is specified in more detail in 3^{rd} Generation Partnership Project (3GPP) technical report (TR) 36.814 V9.0.0, “Further Advancements for E-UTRA Physical Layer Aspects” (Chapter 9).

As example of a relay architecture is shown in FIG. 1. The interface between UE 13 and the RN 12 is named Uu Interface, which is consistent with the Release 8 interface as defined in Long Term Evolution (LTE). The link between the RN 12 and the DeNB 11 is considered as backhaul link and this interface is denoted as Un interface, which is being under standardization in 3GPP.

The eNB shown in FIG. 1 normally supports both types of links at the same time. Up to now, three types of relay are agreed in TR36.814 depending on types of carrier frequency of the link between DeNB 13 and RN 12 and the link between RN 12 and UE 11 and the existence of adequate antenna isolation on RN. These three types are Type-1, Type-1a and Type-1b.

The relay according to Type-1 is an inband relay with resource partitioning. The link between DeNB and RN shares the same carrier frequency with the links between RN and UE and no adequate antenna isolation is used. At this time, the DeNB assigns dedicated sub-frames to links between DeNB and RN, but PRBs of which can also be assigned to DeNB's UEs.

The relay according to Type-1b is an inband relay with resource partitioning. The link between DeNB and RN shares the same carrier frequency with the links between RN and UE, but adequate antenna isolation is used. At this time, the DeNB does not need to assign dedicated sub-frames to links between DeNB and RN. All sub-frames of DeNB are shared by DeNB's RNs and UEs.

The relay according to Type-1a is an outband relay. The link between DeNB and RN uses different carrier frequencies than links between RN and UE. The DeNB does not need to assign dedicated sub-frames to links between DeNB and RN. All sub-frames of DeNB are shared by DeNB's RNs and UEs.

The Mobile Load Balancing (MLB) is one of the most important self-organizing network (SON) features defined in Release 9 for load balancing between eNBs (cf. 3^{rd} Generation Partnership Project (3GPP) technical specification (TS) 36.423 V9.3.0). MLB solution relies on resource status exchanged between neighbors, by X2 message of Resource Status Update. Resource status of neighbors is used by eNB to judge whether MLB should be executed. If it should be executed, mobility parameters to this neighbor will be changed to trigger UEs handover between them.

So far, four MLB parameters are defined in TS36.423 to describe the resource status of one eNB.

The parameter Hardware Load Indicator indicates the status of the Hardware Load experienced by the cell.

The parameter Radio Resource Status indicates the usage of the physical resource blocks (PRBs) in downlink and uplink by the cell.

The parameter S1 TNL Load Indicator indicates the status of the S1 Transport Network Load experienced by the cell.

The parameter Composite Available Capacity Group indicates the overall available resource level in the cell in downlink and uplink.

In order to support MLB also in relay deployment, the straight forward solution is that DeNB/RN works as an eNB to exchange resource status with its neighbors also with X2 message of Resource Status Update to its neighbors. In this case, MLB solution can be reused also in relay deployment without enhancements or modification.

However, with the concept of MLB, the resource status of the backhaul of the eNB is one of the most important inputs to the calculation of S1 TNL Load Indicator and Composite Available Capacity Group at the RN. And the resource status of RN's backhaul link may not be able to be known by RN in some scenarios.

In case of Type-1a and Type-1b, all the available resources that are indicated by four MLB parameters from the DeNB can be used by RN on Un interface, if required. All sub-frames can be used to multiplex the DeNB-UE link and DeNB-RN link because the RN-UE link operates on a different carrier (Type-1a) or the isolation between DeNB-RN link and RN-UE links are enough that the TD multiplexing is not needed among them.

In this case, the RN can induce the resource status of its backhaul link based on MLB parameters in X2 message of Resource Status Update from DeNB.

But it is noted that in real network implementation, an operator may configure a resource division policy on DeNB, e.g. up to 30% resource of DeNB can be used for all its DeNB-RN links while 70% of the resources and probably the unused DeNB-RN link resources are left for its DeNB-UE links. In this case, the RN can still not induce the resource status of its backhaul link just based on MLB parameters from the DeNB, since it describes the resource status of DeNB-UE link, but not DeNB-RN link.

In case of Type-1, if a fixed number of sub-frames are assigned to backhaul link, which will be shared by all RNs, the RN can also not induce the resource status of its backhaul link just based on the resource MLB parameters from the DeNB, since it describes the resource status of DeNB-UE link, but not DeNB-RN link.

If the resource status of the DeNB-RN link is missing from RN, the RN cannot calculate the S1 TNL Load Indicator and Composite Available Capacity Group, since resource status of backhaul is one of important inputs for the calculation of these two parameters. If RN cannot calculate the above MLB parameters, the MLB between RN and its neighbors can not really work.

In the following, three different solutions are proposed in order to solve the above issues. The proposed solutions are preferably for Type-1 relay, but can be also for Type-1a and Type-1b relay.

### SUMMARY OF THE INVENTION

According to the present invention, there are provided methods, apparatuses and a computer program product for enhancements to support Mobility Load Balancing for relay.

According to an aspect of the invention there is provided a method comprising:
receiving a message including first parameters regarding a link between a relay entity and a base station entity;
calculating second parameters regarding the link between the relay entity and the base station entity;
placing the calculated second parameters into the message; and forwarding the message including the first and second parameters to nodes that are connected to the base station.

According to further refinements of the invention as defined under the above aspects,
the message is a X2 message of Resource Status Update according to Long Term Evolution and Long Term Evolution Advanced;
the first parameters are Hardware Load Indicator and Radio Resource Status and the second parameters are S1 TNL Load Indicator and Composite Available Capacity Group according to Mobility Load Balancing of Long Term Evolution and Long Term Evolution Advanced.

According to another aspect of the invention there is provided a method comprising:
receiving a first message including load information regarding a link between the relay entity and a base station entity;
calculating parameters regarding the link between the relay entity and the base station entity based on the received information; and
forwarding a second message including the calculated parameters to the base station entity.

According to another aspect of the invention there is provided a method comprising:
receiving a first message including a first parameter and load information regarding a link between the relay entity and a base station entity;
calculating second parameters regarding the link between the relay entity and the base station entity based on the received first parameter and load information; and
forwarding a second message including the first and second parameters to the base station entity.

According to further refinements of the invention as defined under the above aspects,
the second message is forwarded by the base station entity to other nodes connected to the base station entity;
the first message is a Radio Resource Control message, a X2 message or a S1 message by using Self Organizing Network information;
the second message is a X2 message of Resource Status Update according to Long Term Evolution and Long Term Evolution Advanced;
the parameters are Hardware Load Indicator, Radio Resource Status, S1 TNL Load Indicator and Composite Available Capacity Group according to Mobility Load Balancing of Long Term Evolution and Long Term Evolution Advanced;
the first parameter is S1 TNL Load Indicator and the second parameters are Hardware Load Indicator, Radio Resource Status and Composite Available Capacity Group according to Mobility Load Balancing of Long Term Evolution and Long Term Evolution Advanced.

According to another aspect of the invention there is provided an apparatus comprising:
a receiving unit adapted to receive a message including first parameters regarding a link between a relay entity and a base station entity;
a calculating unit adapted to calculate second parameters regarding the link between the relay entity and the base station entity;
a placing unit adapted to place the calculated second parameters into the message; and
a forwarding unit adapted to forward the message including the first and second parameters to nodes that are connected to the apparatus.

According to further refinements of the invention as defined under the above aspects,
the message is a X2 message of Resource Status Update according to Long Term Evolution and Long Term Evolution Advanced;
the first parameters are Hardware Load Indicator and Radio Resource Status and the second parameters are S1 TNL Load Indicator and Composite Available Capacity Group according to Mobility Load Balancing of Long Term Evolution and Long Term Evolution Advanced.

According to another aspect of the invention there is provided an apparatus comprising:
a receiving unit adapted to receive a first message including load information regarding a link between the relay entity and a base station entity;
a calculating unit adapted to calculate parameters regarding the link between the relay entity and the base station entity based on the received information; and
a forwarding unit adapted to forward a second message including the calculated parameters to the base station entity.

According to another aspect of the invention there is provided an apparatus comprising:
a receiving unit adapted to receive a first message including a first parameter and load information regarding a link between the relay entity and a base station entity;
a calculating unit adapted to calculate second parameters regarding the link between the relay entity and the base station entity based on the received first parameter and load information; and
a forwarding unit adapted to forward a second message including the first and second parameters to the base station entity.

According to further refinements of the invention as defined under the above aspects,
the first message is a Radio Resource Control message, a X2 message or a S1 message by using Self Organizing Network information;
the second message is a X2 message of Resource Status Update according to Long Term Evolution and Long Term Evolution Advanced;
the parameters are Hardware Load Indicator, Radio Resource Status, S1 TNL Load Indicator and Composite Available Capacity Group according to Mobility Load Balancing of Long Term Evolution and Long Term Evolution Advanced;
the first parameter is S1 TNL Load Indicator and the second parameters are Hardware Load Indicator, Radio Resource Status and Composite Available Capacity Group according to Mobility Load Balancing of Long Term Evolution and Long Term Evolution Advanced;

According to a still further aspect of the invention there is provided a computer program product including a program for a processing device, comprising software code portions for performing the steps of the methods as defined above when the program is run on the processing device.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

According to another aspect of the invention there is provided an apparatus comprising:
receiving means for receiving a message including first parameters regarding a link between a relay entity and a base station entity;
calculating means for calculating second parameters regarding the link between the relay entity and the base station entity;
placing means for placing the calculated second parameters into the message; and
forwarding means for forwarding the message including the first and second parameters to nodes that are connected to the apparatus.

According to another aspect of the invention there is provided an apparatus comprising:
receiving means for receiving a first message including load information regarding a link between the relay entity and a base station entity;
calculating means for calculating parameters regarding the link between the relay entity and the base station entity based on the received information; and
forwarding means for forwarding a second message including the calculated parameters to the base station entity.

According to another aspect of the invention there is provided an apparatus comprising:
receiving means for receiving a first message including a first parameter and load information regarding a link between the relay entity and a base station entity;
calculating means for calculating second parameters regarding the link between the relay entity and the base station entity based on the received first parameter and load information; and
forwarding means for forwarding a second message including the first and second parameters to the base station entity.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1 is a diagram showing an interface definition of a relay system according to an embodiment of the present invention;

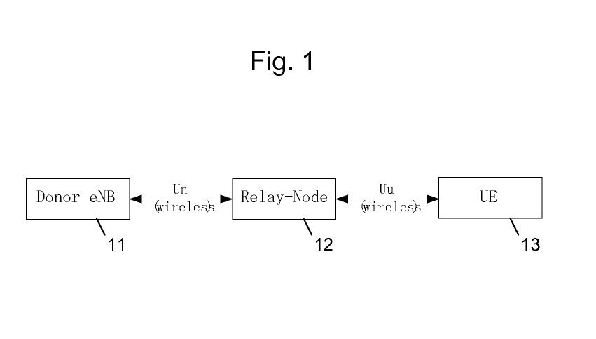

FIG. 2 is a signaling diagram of a resource status update according to an embodiment of the present invention;

FIG. 3 is a signaling diagram of a resource status update according to another embodiment of the present invention;

FIG. 4 is a signaling diagram of a resource status update according to still another embodiment of the present invention;

FIG. 5 is a block diagram showing an example of a DeNB according to an embodiment of the present invention;

FIG. 6 is a block diagram showing an example of a RN according to another embodiment of the present invention;

FIG. 7 is a block diagram showing an example of a RN according to still another embodiment of the present invention.

### DETAILED DESCRIPTION

In the following, embodiments of the present invention are described by referring to general and specific examples of the embodiments. It is to be understood, however, that the description is given by way of example only, and that the described embodiments are by no means to be understood as limiting the present invention thereto.

With relay, the DeNB controls both the DeNB-UE link and also the DeNB-RN link. Then, the DeNB has the best knowledge of the resource status of both the DeNB-UE link and the DeNB-RN link. In the following, three embodiments of the invention are described. According to the first embodiment, the DeNB calculates the S1 TNL Load Indicator and the Composite Available Capacity Group for the RN. According to the second embodiment, the RN itself calculates the S1 TNL Load Indicator and the Composite Available Capacity Group. According to the third embodiment, the DeNB uses the S1 TNL Load Indicator of the Resource Status Update message that is sent to the RN to indicate the resource status of the relay nodes' Un backhaul link. This enables the RN calculating the parameter Composite Available Capacity Group by itself.

### First Embodiment

According to the first embodiment, the DeNB calculates the S1 TNL Load Indicator and the Composite Available Capacity Group for the RN.

In the first embodiment, when the RN sends the X2 message of Resource Status Update to its DeNB, it only calculates and fills the parameters Hardware Load Indicator and Radio Resource Status of the four MLB parameters. The parameters S1 TNL Load Indicator and the Composite Available Capacity Group are left empty or set to zero, since the RN cannot calculate these two parameters if Backhaul Load Information is missing.

When the DeNB receives the X2 message of Resource Status Update from its RN, before forwarding this message, if required, the DeNB calculates and fills in the above two empty parameters S1 TNL Load Indicator and the Composite Available Capacity Group.

The calculation of S1 TNL Load Indicator is mainly based on the DeNB's knowledge to resource status of DeNB-RN link.

The calculation of Composite Available Capacity Group is based on both Hardware Load Indicator and Radio Resource Status from RN, and DeNB's knowledge to resource status of DeNB-RN link.

After filling in the S1 TNL Load Indicator and the Composite Available Capacity Group, the DeNB sends it to the neighbors but also to the Rn that has initiated the message because the RN needs to know the announced values for S1 TNL Load Indicator and the Composite Available Capacity Group.

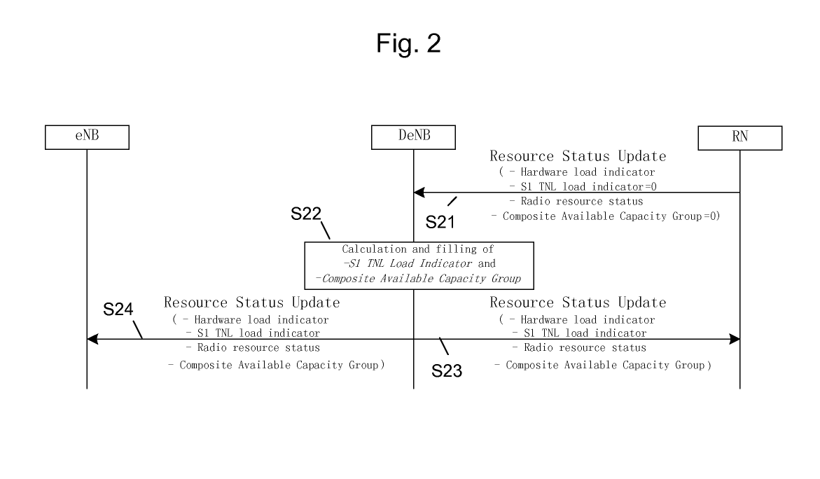

FIG. 2 is a signaling diagram of a resource status update according to the first embodiment of the present invention.

As shown in FIG. 2, in step S21, the RN sends the Resource Status Update message to the DeNB. In this Resource Status Update message, the DeNB sets the parameters S1 TNL Load Indicator and the Composite Available Capacity Group to zero. After receiving the Resource Status Update message from the RN, the DeNB calculates the parameters S1 TNL Load Indicator and the Composite Available Capacity Group, as mentioned above, and fills in the parameters in the Resource Status Update message in step S22. Then, the DeNB forwards the Resource Status Update message to its neighbors, i.e. the eNB, in step S23, and also to the RN that has initiated the message, in step S24.

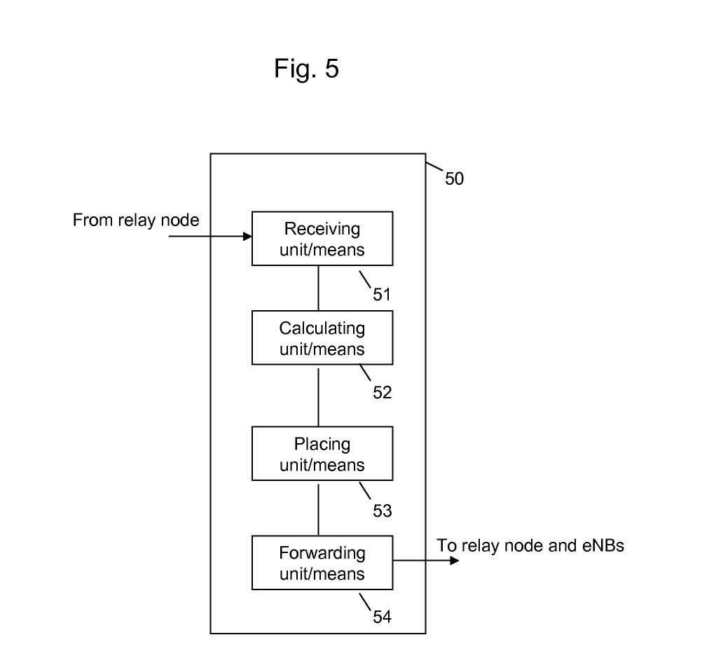

FIG. 5 is a block diagram of an example of a DeNB according to the first embodiment of the present invention.

The DeNB 50 comprises a receiving unit 51 that receives the Resource Status Update message from the RN. The receiving unit 51 is connected to a calculating unit 52 which calculates the parameters S1 TNL Load Indicator and the Composite Available Capacity Group. Then, a placing unit 53 connected to the calculating unit 52 places the parameters calculated by the calculating unit 52 into the Resource Status Update message. A forwarding unit 54 connected to the placing unit 53 forwards the Resource Status Update message to the RN and to other eNBs connected to the DeNB 50.

### Second Embodiment

According to the second embodiment, the RN calculates the parameters S1 TNL Load Indicator and the Composite Available Capacity Group by itself. In order to support the RN to calculate all MLB parameters by itself, the resource status of the DeNB-RN link should be provided to the RN in advance, since it is mandatory for the calculation of the MLB Parameters.

In the second embodiment, a message Backhaul Load Info is defined, which describes the load status of the DeNB-RN link. The DeNB then sends this Backhaul Load Info message to the RN, when the resource status of DeNB-RN link is changed and needs to be known by the RN, if the change is big enough to impact the MLB between the RN and its neighbors.

As to the transmission of the Backhaul Load Info message from the DeNB to the RN, there are several possibilities.

The Backhaul Load Info message can be defined as one information element (IE) to be carried by an available radio resource controller (RRC) message or a new defined RRC message. In this regard, it is noted that this message is not limited to the Backhaul Load Info message and that another name may be used in a future standard to replace the Backhaul Load Info message with the same concept and philosophy in the context of the present invention.

As an alternative, the Backhaul Load Info message can be defined as one IE to be carried by an available X2 message or a new defined X2 message.

It is noted that this is not limited to RRC or X2 messages and any other message from the DeNB to the RN can also be used for this purpose (i.e. MAC).

For example, the information could also be sent via a S1 Mobility Management Entity (MME) Configuration Transfer message. In such a case, a SON Information IE is included in the MME Configuration Transfer message. This IE could be enhanced with the Backhaul Load Info message.

The Backhaul Load Info message can include the following information, but is not limited thereto.

The Backhaul Load Info message can include the parameter Composite Available Capacity Group of the DeNB-RN link. This parameter is obtained depending on available information about the DeNB-RN link, such as available PRBs, QoS type of traffic, link condition with this Rn, and so on.

The message can further include resource planning for different QoS traffic by the DeNB and/or any other required information, which can help the RN to calculate MLB parameters more accurately.

The RN uses the Backhaul Load Info message from the DeNB to calculate the MLB Parameters, such as S1 TNL Load Indicator and Composite Available Capacity Group, by itself.

According to the second embodiment, the RN can calculate the parameters S1 TNL Load Indicator and Composite Available Capacity Group more accurately based on a more accurate resource status of its backhaul link, and thus can provide better performance.

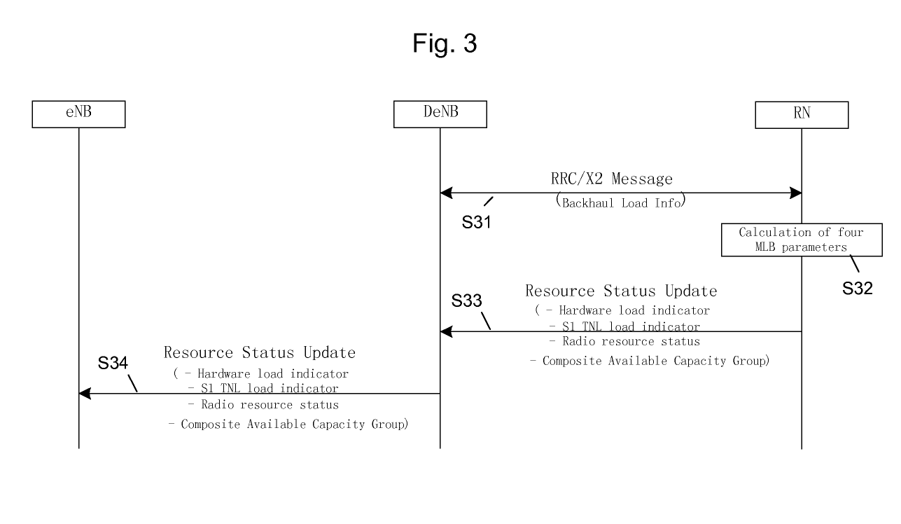

FIG. 3 is a signaling diagram of a resource status update according to the second embodiment of the present invention.

As shown in FIG. 3, when a resource status of the DeNB-RN link is changed and needs to be known by the RN, in step S31, the DeNB uses an available or new defined RRC/X2 message to send a new defined Backhaul Load Info message to the RN. Based on the Backhaul Load Info message from the DeNB, in step S32, the RN calculates all MLB parameters and sends the Resource Status Update message to the DeNB in step S33. In step S34, the DeNB directly forwards the received Resource Status Update message, if required, to its neighbors, i.e. the eNB in this case, without any modification.

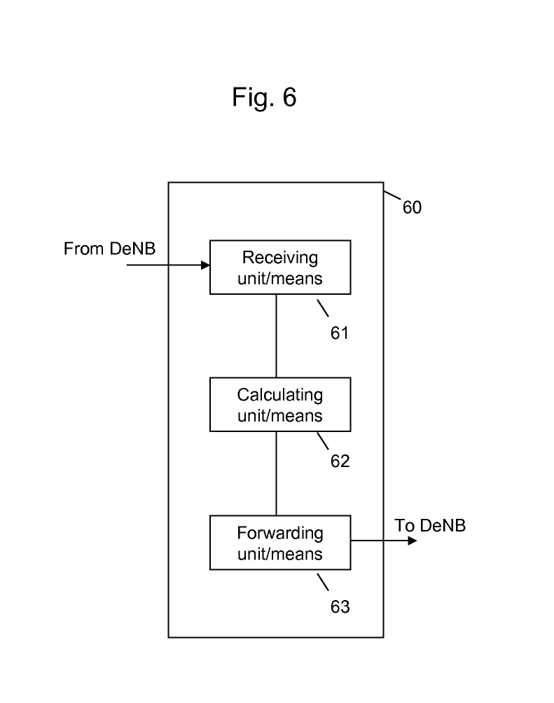

FIG. 6 is a block diagram showing an example of a RN according to the second embodiment of the present invention.

The RN 60 comprises a receiving unit 61 which receives the RRC, x2 or any other message from the DeNB including Backhaul Load Info. Then, a calculating unit 62 connected to the receiving unit 61 calculates the four MLB parameters Hardware Load Indicator, Radio Resource Status, S1 TNL Load Indicator and Composite Available Capacity Group. Then, the RN 60 forwards the Resource Status Update message including the four parameters calculated by the calculating unit 62 via a forwarding unit 63 connected to the calculating unit 62 to the DeNB. The DeNB may then forward this message to the other eNBs connected thereto, as described above.

### Third Embodiment

According to the third embodiment, the DeNB indicates the S1 TNL Load Indicator to RN, and RN calculates the parameter Composite Available Capacity Group by itself.

In third embodiment, when DeNB sends Resource Status Update to RN, S1 TNL Load Indicator within this message actually does not indicate the backhaul resource status of DeNB, but indicate the backhaul resource status of RN.

The RN uses the S1 TNL Load Indicator from DeNB, which describes its backhaul resource status, to calculate the Composite Available Capacity Group, by itself.

When S1 TNL Load Indicator and Composite Available Capacity Group are available, RN further calculate other two parameters and then send the Resource Status Update to DeNB.

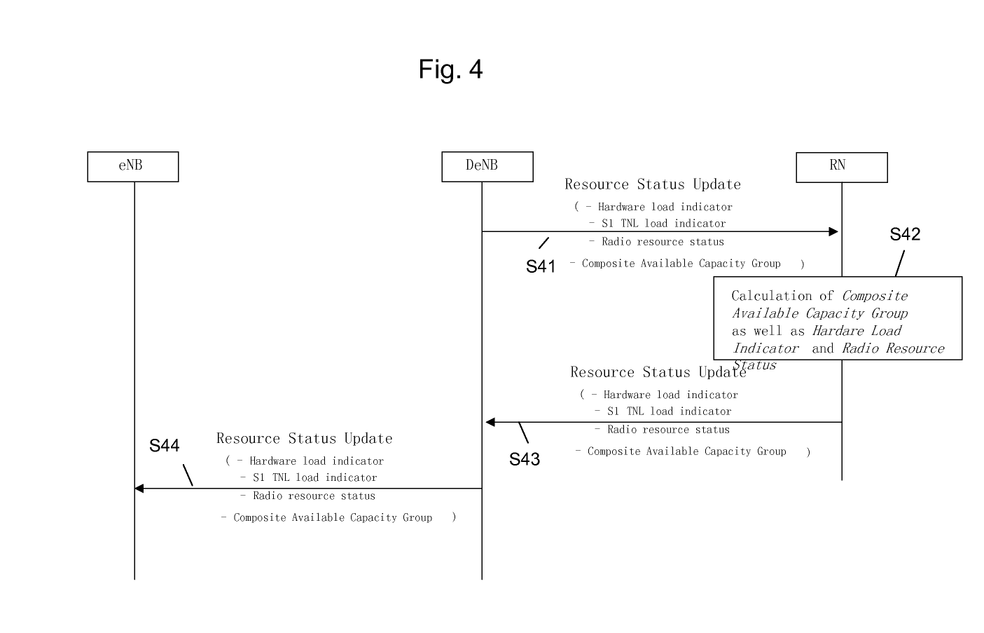

FIG. 4 is a signaling diagram of a resource status update according to the third embodiment of the present invention.

As shown in FIG. 4, in step S41, when DeNB sends resource status to RN, it uses S1 TNL Load Indicator to describe its backhaul resource status. Based on above backhaul resource status from DeNB, in step S42, RN calculates the parameter Composite Available Capacity Group. The RN also calculates the parameters Hardware Load Indicator and Radio resource status (this can be done independently from the received backhaul resource status. For the value of the S1 TNL load indicator the corresponding value of the last received Resource Status Update message, received in step S41, is used. Then the RN sends the Resource Status Update message to the DeNB in step S43. In step S44, the DeNB directly forwards the received Resource Status Update message, if required, i.e. to the eNB in this case, without any modification.

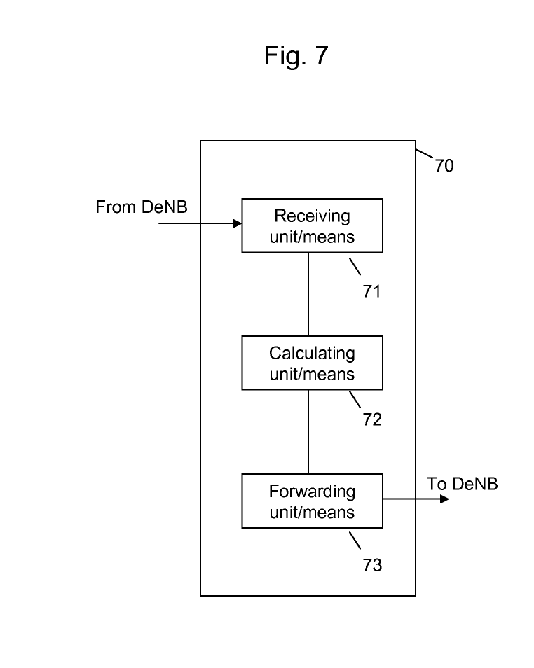

FIG. 7 is as block diagram showing an example of a RN according to the third embodiment of the present invention.

The RN 70 comprises a receiving unit 71 which receives the X2 message from the DeNB including the parameter S1 TNL Load Indicator. Then, a calculating unit 72 connected to receiving unit 71 calculates the Composite Available Capacity Group based on S1 TNL Load Indicator from DeNB, and also other MLB parameters Hardware Load Indicator, Radio Resource Status. Then, the RN 70 forwards the Resource Status Update message including the four parameter calculated by the calculating unit 72 via a forwarding unit 53 connected to the calculating unit 72 to the DeNB. Then DeNB may then forward this message to the other eNBs connected thereto, as described above.

As described above, specific embodiments of the present invention provides a procedure for allowing neighbor eNBs of a relay node to understand the backhaul and radio resources available at the relay node by either allowing the RN to calculate such resource or by providing the RN with overall available resource information. Thus, a relay node is allowed to provide valid load and resource information to neighbor eNBs.

In the foregoing exemplary description of the RN and the DeNB, only the units that are relevant for understanding the principles of the invention have been described using functional blocks. The DeNB and RN may comprise further units that are necessary for their respective operation. However, a description of these units is omitted in this specification. The arrangement of the functional blocks of the devices is not construed to limit the invention, and the functions may be performed by one block or further split into sub-blocks.

For the purpose of the present invention as described herein above, it should be noted that
method steps likely to be implemented as software code portions and being run using a processor at a network control element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and general and specific examples described above are provided for illustrative purposes only and are in no way intended that the present invention is restricted thereto. Rather, it is the intention that all variations and modifications be included which fall within the scope of the appended claims.

1. A method, comprising:
receiving a message including first parameters regarding a link between a relay entity and a base station entity;
calculating second parameters regarding the link between the relay entity and the base station entity;
placing the calculated second parameters into the message; and
forwarding the message including the first and second parameters to nodes that are connected to the base station.

2. The method according to claim 1, wherein the message is a X2 message of Resource Status Update according to Long Term Evolution and Long Term Evolution Advanced.

3. The method according to claim 1, wherein the first parameters are Hardware Load Indicator and Radio Resource Status and the second parameters are S1 TNL Load Indicator and Composite Available Capacity Group according to Mobility Load Balancing of Long Term Evolution and Long Term Evolution Advanced.

4. A method, comprising:
receiving a first message including load information regarding a link between the relay entity and a base station entity;
calculating parameters regarding the link between the relay entity and the base station entity based on the received information; and
forwarding a second message including the calculated parameters to the base station entity.

5. A method, comprising:
receiving a first message including a first parameter and load information regarding a link between the relay entity and a base station entity;
calculating second parameters regarding the link between the relay entity and the base station entity based on the received first parameter and load information; and
forwarding a second message including the first and second parameters to the base station entity.

6. The method according to claim 4, wherein the second message is forwarded by the base station entity to other nodes connected to the base station entity.

7. The method according to claim 4, wherein the first message is a Radio Resource Control message, a X2 message or a S1 message by using Self Organizing Network information.

8. The method according to claim 4, wherein the second message is a X2 message of Resource Status Update according to Long Term Evolution and Long Term Evolution Advanced.

9. The method according to claim 4, wherein the parameters are Hardware Load Indicator, Radio Resource Status, S1 TNL Load Indicator and Composite Available Capacity Group according to Mobility Load Balancing of Long Term Evolution and Long Term Evolution Advanced.

10. The method according to claim 5, wherein the first parameter is S1 TNL Load Indicator and the second parameters are Hardware Load Indicator, Radio Resource Status and Composite Available Capacity Group according to Mobility Load Balancing of Long Term Evolution and Long Term Evolution Advanced.

11. An apparatus, comprising:
a receiving unit adapted to receive a message including first parameters regarding a link between a relay entity and a base station entity;
a calculating unit adapted to calculate second parameters regarding the link between the relay entity and the base station entity;
a placing unit adapted to place the calculated second parameters into the message; and
a forwarding unit adapted to forward the message including the first and second parameters to nodes that are connected to the apparatus.

12. The apparatus according to claim 11, wherein the message is a X2 message of Resource Status Update according to Long Term Evolution and Long Term Evolution Advanced.

13. The apparatus according to claim 11, wherein the first parameters are Hardware Load Indicator and Radio Re-source Status and the second parameters are S1 TNL Load indicator and Composite Available Capacity Group according to Mobility Load Balancing of Long Term Evolution and Long Term Evolution Advanced.

14. An apparatus, comprising:
a receiving unit adapted to receive a first message including load information regarding a link between the relay entity and a base station entity;
a calculating unit adapted to calculate parameters regarding the link between the relay entity and the base station entity based on the received information; and
a forwarding unit adapted to forward a second message including the calculated parameters to the base station entity.

15. An apparatus, comprising:
a receiving unit adapted to receive a first message including a first parameter and load information regarding a link between the relay entity and a base station entity;
a calculating unit adapted to calculate second parameters regarding the link between the relay entity and the base station entity based on the received first parameter and load information; and
a forwarding unit adapted to forward a second message including the first and second parameters to the base station entity.

16. The apparatus according to claim 14, wherein the first message is a Radio Resource Control message, a X2 message or a S1 message by using Self Organizing Network information.

17. The apparatus according to claim 14, wherein the second message is a X2 message of Resource Status Update according to Long Term Evolution and Long Term Evolution Advanced.

18. The apparatus according to claim 14, wherein the parameters are Hardware Load Indicator, Radio Resource Status, S1 TNL Load Indicator and Composite Available Capacity Group according to Mobility Load Balancing of Long Term Evolution and Long Term Evolution Advanced.

19. The apparatus according to claim 15, wherein the first parameter is S1 TNL Load Indicator and the second parameters are Hardware Load Indicator, Radio Resource Status and Composite Available Capacity Group according to Mobility Load Balancing of Long Term Evolution and Long Term Evolution Advanced.

20. A computer program product including a program for a processing device, comprising software code portions for performing the steps of claim 1 when the program is run on the processing device.

21. The computer program product according to claim 20, wherein the computer program product comprises a computer-readable medium on which the software code portions are stored.

22. The computer program product according to claim 20, wherein the program is directly loadable into an internal memory of the processing device.

23. An apparatus, comprising:
receiving means for receiving a message including first parameters regarding a link between a relay entity and a base station entity;
calculating means for calculating second parameters regarding the link between the relay entity and the base station entity;
placing means for placing the calculated second parameters into the message; and
forwarding means for forwarding the message including the first and second parameters to nodes that are connected to the apparatus.

24. An apparatus, comprising:
receiving means for receiving a first message including load information regarding a link between the relay entity and a base station entity;
calculating means for calculating parameters regarding the link between the relay entity and the base station entity based on the received information; and
forwarding means for forwarding a second message including the calculated parameters to the base station entity.

25. An apparatus, comprising:
receiving means for receiving a first message including a first parameter and load information regarding a link between the relay entity and a base station entity;
calculating means for calculating second parameters regarding the link between the relay entity and the base station entity based on the received first parameter and load information; and
forwarding means for forwarding a second message including the first and second parameters to the base station entity.
